(19) United States
(12) Patent Application Publication
(10) Pub. No.: US 2005/0053704 A1
(43) Pub. Date: Mar. 10, 2005

(54) Acidic composition and its uses

(75) Inventors: Maurice Clarence Kemp, Lincoln, CA (US); Robert Blaine Lalum, Antelope, CA (US); Zhong Wei Xie, Folsom, CA (US)

Correspondence Address: T. Ling Chwang, Suite 600, 2435 N. Central Expressway, Richardson, TX, 75080, US

(73) Assignee: Mionix Corporation, Rocklin, CA (US)

(21) Appl. No.: 10/799,354

(22) Filed: Mar. 12, 2004

Related U.S. Application Data
(60) Provisional application No. 60/454,255, filed on Mar. 13, 2003.

(51) Int. Cl. A23K 1/00

(52) U.S. Cl. 426/335

(57) ABSTRACT

An acidic composition of one or more organic acids blended with an acidulant. The acidulant may be a low pH solution of sparingly-soluble Group IIA-complexes (“AGIIS”), a highly acidic metalated organic acid (“HAMO”), a highly acidic metalated mixture of inorganic acids (“HAMMIA”), one or more strong inorganic acids, or an acidic salt. The acidic composition is an effective bacteriostatic preservative against pathogenic microorganisms which may be present in food products. Contacting ready-to-eat food products such as frankfurters, as well as raw animal carcasses, with the acidic composition causes a reduction in the number of detectable microbes for an extended period of time.

This application claims priority to U.S. Provisional Patent Application Ser. No. 60/454,255, entitled “Acidic Composition and Its Uses” filed on Mar. 13, 2003, the entire content of which is hereby incorporated by reference.

### BACKGROUND

This invention relates to an acidic composition for inhibiting the growth of pathogenic microorganisms on food products and its method of use. In particular, the acidic composition inhibits the growth of pathogenic microorganisms on ready-to-eat food products.

One aspect of this invention relates to an acidic composition which is effective at eradicating pathogens from food products, and in particular to eradicating pathogens from ready-to-eat food products.

Eliminating microbial pathogens from food products is currently a matter of significant public health concern. Harmful microbial organisms which may be present in meat products include Staphylococcus, Campylobacter jejuni, Salmonella, Clostridium perfringes, Toxoplasma gondii, and Botulism. Two organisms in particular pose the most immediate risks: Escherichia coli and Listeria monocytogenes.

Escherichia coli is a bacterium naturally found in the intestinal tracts of animals and humans. One particular rare strain, E. coli 0157:H7, is a member of the enterohemorrhagic E. coli group. This strain of bacteria produces the Shiga-like toxin, or as it is sometimes called, Vero toxin. The toxin is a protein which causes severe damage to intestinal epithelial cells, leading to the loss of water and salts, damage to blood vessels, and hemorrhaging. In some cases hemolytic uremic syndrome occurs, which is characterized by kidney failure and loss of red blood cells. In severe cases, the disease can cause permanent kidney damage. E. coli 0157:H7 is particularly dangerous to small children, the elderly, and the infirm. An estimated 73,000 cases of infection and 61 deaths occur in the United States each year. Most illness has been associated with eating undercooked, contaminated ground beef.

Eradicating E. coli 0157:H7 from meat products is a significant challenge facing the beef industry today. Recalls of large amounts of tainted ground beef have been harmful to producers economically, as well as damaging to public opinion. Efforts to eliminate the incidence of E. coli 0157:H7 have so far focused on expanded intervention procedures, standardized testing, and consumer education as well as microbial control.

Listeria monocytogenes is a foodborne pathogen of significant public health concern due to its virulence in susceptible individuals, and as a consequence has received a presidential mandate for reduction to decrease the incidence of foodborne illness. L. monocytogenes is a facultative, intracellular gram-positive, nonsporeforming and psychrotrophic bacterium that causes the disease called listeriosis. Immunocompromised individuals, infants, pregnant women and elderly persons are the most at risk. Listeriosis can cause high fever, severe headache, neck stiffness and nausea. In humans, the primary manifestations of listeriosis are meningitis, abortion and prenatal septicemia. The estimated annual incidence of listeriosis in the United States is 1850 cases resulting in 425 deaths. Although foodborne listeriosis is rare, the associated mortality rate is as high as 20% among those at risk. The infectious dose of L. monocytogenes is unknown. It is an ubiquitous organism able to survive and multiply at refrigeration temperatures in the presence or absence of oxygen, and can tolerate a range of pHs and concentrations of up to 12-13% salt. Moreover, some strains may grow at a water activity (a_{w}) as low as 0.9 and at a pH value as low as 4.4 (Walker et al., J. App. Bacteriol., vol. 68, pp. 157-62, 1990; Farber and Peterkin, Microbiol. Rev., vol. 55, pp. 476-511, 1991; Miller, J. Food Prot., vol. 55, pp. 414-18, 1992).

Ready-to-eat (“RTE”) products, such as hot dogs, lunchmeats, smoked fish, and certain types of soft cheeses, are among the foods most commonly associated with food-related listeriosis. Thus, a “zero tolerance” for L. monocytogenes in RTE foods has been specified by FDA based on the characteristics of this microorganism and the reported cases of listeriosis (Ryser and Marth, Listeria, Listeriosis and Food Safety, 1999). Contamination of RTE food products with L. monocytogenes primarily occurs post-processing and prior to consumption of these products. Even though cured RTE meat products contain sodium chloride and nitrite salts in their formulations that possess antimicrobial properties, they are not able to inhibit the growth of L. monocytogenes under refrigerated storage conditions (Mbandi and Shelef, Int. J. Food Micro., vol. 76, pp. 191-98, 2002). The unusual growth and survival properties of the organism and its ability to adhere to food contact surfaces contribute to the complexity of eliminating it from the food processing environment.

The safety of RTE food products, which may be consumed without additional heat treatment, can be enhanced by adding substances to serve as microbiological hurdles and suppress the growth of pathogenic microorganisms such as L. monocytogenes. Such hurdles include pH lowering substances such as lactic acid and other organic compounds. Typically, when acids and other organic compounds are incorporated into RTE foods such as meats and cheeses, these substances must be added at low concentrations in order to avoid adverse effects on the taste of the food.

Antilisterial effects of organic acids, their salts or combinations have been examined in several types of meat products. Shelef and Yang, J. Food Prot., vol. 54, pp. 283-87, 1991, showed growth suppression of L. monocytogenes by lactate (4%) in sterile broth, and on chicken and beef. Chen and Shelef, J. Food Prot., vol. 55, pp. 574-78, 1992, studied the relationship between water activity (a_{w}), salts of lactic acid, and growth of L. monocytogenes strain Scott A in a meat model system. They found that lactate concentrations less than 4% were not listeristatic, but combinations of 2 or 3% lactate with 2% NaCl inhibited the growth of L. monocytogenes. Sodium lactate (3 or 4%) was found to be effective against the growth of L. monocytogenes in cooked beef stored at 10° C. when compared to 0 or 2% (Miller and Acuff, J. Food Sci., vol. 59, pp. 15-19, 1994). Artificial contamination of frankfurters with L. monocytogenes followed by a 2 minute dip in 1% lactic, acetic, tartaric, or citric acids resulted in a 1-2 log kill of the bacteria (Palumbo and Williams, Food Micro., vol. 11(4), pp. 293-300, 1994). However, surviving bacteria recovered and began to grow during refrigerated storage.

By dipping in 5% acetic or lactic acid, L. monocytogenes was not only killed, but also prevented from growing during 90 days of refrigerated storage. Mbandi and Shelef, J. Food Prot., vol. 64, pp. 640-44, 2001, found enhanced inhibition of L. monocytogenes Scott A in sterile comminuted beef at 5 and 10° C. using a combination of sodium lactate (2.5%) and sodium diacetate (0.2%). They also evaluated the inhibitory effect of these salts alone and in combination in RTE meat inoculated with single strain or a cocktail of six strains of Listeria. These salts delayed growth of listeriae at 5° C. and the effect of their combination was listericidal for L. monocytogenes Scott A and listeristatic for the six-strain mixture (Mbandi and Shelef, 2002).

Sodium and/or potassium lactate at levels of 2 to 4% have been shown to act as bacteriostatic agents against pathogenic bacteria such as L. monocytogenes, E. coli O157:H7 and Salmonella when incorporated into a variety of RTE meat products (Houstma et al., J. Food Prot., vol. 59(12), pp. 1300-1304, 1996; Murano and Rust, J. Food Quality, vol. 18(4), pp. 313-23, 1995; Nerbrink et al., Int. J. Food Micro., vol. 47(1/2), pp. 99-109, 1999; Shelef, J Food Prot., vol. 57(5), pp. 445-450, 1994; Stekelenburg, Int. J. Food Micro., vol. 66, pp. 197-203, 2001). Sodium or potassium lactate is available commercially as a neutral aqueous solution (60%), and approved for use as a flavoring agent at levels of up to 4.8% in emulsified products (9 CFR 424.21, 2002) such as frankfurters, bologna and wieners. Both may be used at concentrations up to 4.8% (or a concentration of 2.9% of a 100% solution) as a secondary ingredient to inhibit the growth of pathogenic bacteria in refrigerated, RTE, hermetically packaged, cooked, uncured and cured meats. Therefore, the incorporation or a surface application of lactate could potentially afford protection against pathogen outgrowth in or on RTE products and provide additional protection to consumers.

One option available to the beef industry for elimination of harmful pathogens from raw beef is irradiation of the meat products. Although this technique has been shown to be effective, it has yet to be accepted as an ideal alternative. Beef industry representatives have expressed concern over the effects of irradiation on the “organoleptic” qualities of the meat, or its taste, smell, and appearance. Furthermore, there is hesitancy regarding the U.S.'s capacity to irradiate meat on a large scale.

Because a great deal of contamination of meat products with harmful microbes takes place at processing facilities, attempts to control pathogenic growth have also focused on carcass washing. Carcass washing involves subjecting those portions of the slaughtered animal which will be processed into food products to a chemical spray or steam bath. The washing may take place at multiple stages during processing, including pre- and post-evisceration. Chemical sprays used often include dilute solutions of lactic or acetic acids. Although varying degrees of success have been achieved, current carcass washing methods have not yet been shown to reduce the numbers of pathogenic microorganisms to a level regarded as safe.

### SUMMARY

One embodiment of the current invention, an acidic composition (blended or unblended), has been shown to dramatically reduce the total numbers of aerobic bacteria on the surface of RTE food products. All of the ingredients in the acidic composition are affirmed as GRAS (generally recognized as safe) under the FDA Code. The acidic composition has the ability to be an effective bacteriostatic preservative against pathogenic microorganisms such as L. monocytogenes. Thus, this acidulant, when incorporated into or applied to the surface of RTE food products, affords a degree of protection against pathogens that has not been demonstrated by other products.

One embodiment of the acidic composition can be prepared by blending organic acids in higher than normal concentrations with an acidulant to maintain a low pH. The low pH effectively keeps the organic acids in a protonated state and increases the anti-microbial efficacy. Any of a number of organic acids may be blended to create the acidic solution, although the small carboxylic acids are preferred. The acidulant may be a low pH solution of sparingly-soluble Group IIA-complexes (“AGIIS”), a highly acidic metalated organic acid (“HAMO”), a highly acidic metalated mixture of inorganic acids (“HAMMIA”), a strong inorganic acid, or an acidic salt. A metal salt of an inorganic or organic acid, preferably a Group I or II metal salt, may be added as well. Other optional additives include alcohols, peroxides, and surfactants.

In another embodiment, the acidic composition comprises a certain organic acid or a mixture of organic acids, at a relatively high concentration, which also reduces the total number of pathogens on the surface of food products, including RTE food products. In a further embodiment, RTE food products may be preserved through contact with an acidulant.

### DETAILED DESCRIPTION OF PREFERRED EMBODIMENTS

One aspect of the present invention pertains to a solution of organic acids which may be used to acidify foods, and particularly meat products, in order to eradicate harmful pathogens. Any of a number of organic acids may be used. The most preferred organic acids are small carboxylic acids such as propionic acid, lactic acid, and acetic acid. Other organic acids which may be used include butyric acid, citric acid, glycolic acid, pyruvic acid, ascorbic acid, and gluconic acid. Final concentrations of these blended organic acids, which may be used in any combination, may be anywhere from 40,000 to 300,000 ppm. A more preferred concentration of the organic acids, alone or in combination, is from 45,000 ppm to 250,000 ppm. The most preferred concentration is from 50,000 ppm to 150,000 ppm. Benzoic acid and sorbic acid may also be used, although their use in food products is more restricted. These two acids may be used in concentration from 0.05% to 0.2%, preferably from 0.1% to 0.2%, and most preferably from 0.15% to 0.2%.

Because the anti-microbial efficacy of the organic acids is improved when pH levels are low, they may be blended with an acidulant. The acidulant may be present at concentrations from about 1% to 85% and may be: (1) a low pH solution of sparingly-soluble Group IIA-complexes (“AGIIS”); (2) a highly acidic metalated organic acid (“HAMO”); (3) a highly acidic metalated mixture of inorganic acids (“HAMMIA”); (4) a strong inorganic acid; or (5) an acidic salt. The amount of acidulant used will vary depending on each application. Fermented foods will generally require more acidulant, while bland foods will require less. When the acidulant used is a strong inorganic acid, it is preferable to use the minimum amount of inorganic acid that will lower the pH below the pH of the organic acid if the organic acid was present at 45,000 ppm and mixed with water. The final pH of the acidic solution should preferably be between about 1.0 and about 5.0.

The composition of blended organic acids, with or without an acidulant, may also contain one or more additives. These additives include salts, alcohols, peroxides, and surfactants. The salts may be any metal salt of an inorganic or organic acid. Group I and II metal salts of organic acids or inorganic acids are preferred. Salts of the preferred organic and inorganic acids listed above are the most preferred. If the salt used is a metal salt of an organic acid, it can be present at a concentration of from 5000 ppm to 60,000 ppm. A more preferred range is from 10,000 ppm to 55,000 ppm. The most preferred range is from 20,000 ppm to 50,000 ppm. If the salt is a metal salt of an inorganic acid, it can be present at a concentration of from 5000 ppm to 50,000 ppm. A more preferred range is from 10,000 ppm to 40,000 ppm. The most preferred range is from 15,000 ppm to 30,000 ppm. Alternatively, a salt can be generated within the composition by adding a base material to the final solution. The most preferred bases which may be added in this manner are Group I and II hydroxides or carbonates. If a base material is used, it should be present in a concentration of from 5000 ppm to 60,000 ppm. A more preferred range is from 10,000 ppm to 40,000 ppm. The most preferred range is from 15,000 ppm to 30,000 ppm.

An additional additive may be an alcohol or a peroxide. The most preferred alcohol is ethanol, which may be present at a concentration of from 0.025-5%, more preferably from 0.05-2%, and most preferably from 0.075-1%. Preferred peroxides include hydrogen peroxide, calcium peroxide, and peracetic acid. Other peroxides that may be used include calcium peroxide and sodium peroxide. The peroxide additive can be present in a concentration from 25 ppm to 150 ppm, more preferably from 40 ppm to 90 ppm, and most preferably from 50 ppm to 80 ppm.

A surfactant additive for the present invention is a surface-active agent. It is usually an organic compound consisting of two parts: One, a hydrophobic portion, usually including a long hydrocarbon chain; and two, a hydrophilic portion which renders the compound sufficiently soluble or dispersible in water or another polar solvent. Surfactants are usually classified into: (1) anionic, where the hydrophilic moiety of the molecule carries a negative charge; (2) cationic, where this moiety of the molecule carries a positive charge; and (3) non-ionic, which do not dissociate, but commonly derive their hydrophilic moiety from polyhydroxy or polyethoxy structures. Amphoteric surfactants are those which may be either cationic or anionic depending on the pH. Other surfactants include ampholytic and zwitterionic surfactants. Preferred surfactants for the present invention include polypropyleneglycol (2000 and 4000), polysorbates (Tween 80 and Tween 20), sodium dodecyl sulfate (“SDS”), linear alkylbenzene sulfonate (“LAS”), dodecylbenzene sulfonic acid (“DBSA”), and mixtures thereof. Other derivatives of LAS, as well as any surfactant approved for use in food, may also be used. The surfactant may be present in a concentration from about 100 ppm to 20,000 ppm, more preferably from 250 ppm to 10,000 ppm, and most preferably from 500 ppm to 5000 ppm. If a surfactant is included as an additive, oleic acid may also be added to help control foaming.

A first acidulant which may be used in the current acidic solution is an acidic or low pH solution of sparingly-soluble Group IIA complexes (“AGIIS”), which may have a suspension of very fine particles. The term “low pH” means the pH is below 7, in the acidic region. The AGIIS has a certain acid normality but does not have the same dehydrating behavior as a saturated calcium sulfate in sulfuric acid having the same normality. In other words, the AGIIS has a certain acid normality but does not char sucrose as readily as does a saturated solution of calcium sulfate in sulfuric acid having the same normality. Further, the AGIIS has low volatility at room temperature and pressure. It is less corrosive to a human skin than sulfuric acid saturated with calcium sulfate having the same acid normality. Not intending to be bound by the theory, it is believed that one embodiment of AGIIS comprises near-saturated, saturated, or super-saturated calcium, sulfate anions or variations thereof, and/or complex ions containing calcium, sulfates, and/or variations thereof.

The term “complex,” as used herein, denotes a composition wherein individual constituents are associated. “Associated” means constituents are bound to one another either covalently or non-covalently, the latter as a result of hydrogen bonding or other inter-molecular forces. The constituents may be present in ionic, non-ionic, hydrated or other forms.

The AGIIS can be prepared in several ways. Some of the methods involve the use of Group IA hydroxide but some of syntheses are devoid of the use of any added Group IA hydroxide, although it is possible that a small amount of Group IA metal may be present as “impurities.” The preferred way of manufacturing AGIIS is not to add Group IA hydroxide to the mixture. As the phrase implies, AGIIS is highly acidic, ionic, with a pH of below about 7, preferably below about 2. See, “Acidic Solution of Sparingly-Soluble Group IIA Complexes,” U.S. application Ser. No. 09/500,473, filed Feb. 9, 2000, the entire content of which is hereby incorporated by reference. See also, “Highly Acidic Metalated Organic Acid as a Food Additive,” U.S. Application Ser. No. 09/766,546, filed Jan. 19, 2001, the entire content of which is hereby incorported by reference.

A preferred method of preparing AGIIS involves mixing a mineral acid with a Group IIA hydroxide, or with a Group IIA salt of a dibasic acid, or with a mixture of the two Group IIA materials. In the mixing, a salt of Group IIA is also formed. Preferably, the starting Group IIA material or materials selected will give rise to, and form, the Group IIA salt or salts that are sparingly soluble in water. The preferred mineral acid is sulfuric acid, the preferred Group IIA hydroxide is calcium hydroxide, and the prefer Group IIA salt of a dibasic acid is calcium sulfate. Other examples of Group IIA salt include calcium oxide, calcium carbonate, and “calcium bicarbonate.”

Thus, for example, AGIIS can be prepared by mixing or blending starting materials given in one of the following scheme with good reproducibility:
(1) H₂SO₄ and Ca(OH)₂;
(2) H₂SO₄, Ca(OH)₂, and CaCO₃;
(3) H₂SO₄, Ca(OH)₂, CaCO₃, and CO₂ (gas);
(4) H₂SO₄, CaCO₃, and Ca(OH)₂;
(5) H₂SO₄, Ca(OH)₂, and CaSO₄;
(6) H₂SO₄, CaSO₄, CaCO₃, and Ca(OH)₂;
(7) H₂SO₄, CaSO₄, CaCO₃, and CO₂ (gas); and
(8) H₂SO₄, CaSO₄, CaCO₃, CO₂ (gas), and Ca(OH)₂.

Preferably, AGIIS is prepared by mixing calcium hydroxide with concentrated sulfuric acid, with or without an optional Group IIA salt of a dibasic acid (such as calcium sulfate) added to the sulfuric acid. The optional calcium sulfate can be added to the concentrated sulfuric acid prior to the introduction of calcium hydroxide into the blending mixture. The addition of calcium sulfate to the concentrated sulfuric acid appears to reduce the amount of calcium hydroxide needed for the preparation of AGIIS. Other optional reactants include calcium carbonate and gaseous carbon dioxide being bubbled into the mixture. Regardless of the use of any optional reactants, it was found that the use of calcium hydroxide is desirable.

One preferred method of preparing AGIIS can be described briefly as: Concentrated sulfuric acid is added to chilled water (8°-12° C.) in the reaction vessel, then, with stirring, calcium sulfate is added to the acid in chilled water to give a mixture. Temperature control is paramount to this process. To this stirring mixture is then added a slurry of calcium hydroxide in water. The solid formed from the mixture is then removed. This method involves the use of sulfuric acid, calcium sulfate, and calcium hydroxide, and it has several unexpected advantages. Firstly, this reaction is not violent and is not exceedingly exothermic. Besides being easy to control and easy to reproduce, this reaction uses ingredients each of which has been reviewed by the U.S. Food and Drug Administration (“U.S. FDA”) and determined to be “Generally Recognized As Safe” (“GRAS”). As such, each of these ingredients can be added directly to food, subject, of course, to certain limitations. Under proper concentration, each of these ingredients can be used as processing aids and in food contact applications. Their use is limited only by product suitability and current Good Manufacturing Practices (“cGMP”). The AGIIS so prepared is thus safe for animal consumption, safe for processing aids, and safe in food contact applications. Further, the AGIIS reduces biological contaminants in not only inhibiting the growth of, and killing, microorganisms but also destroying the toxins formed and generated by the microorganisms. The AGIIS formed can also preserve, or extend the shelf-life of, consumable products, be they plant, animal, pharmaceutical, or biological products. It also preserves or improves the organoleptic quality of a beverage, a plant product or an animal product. It also possesses certain healing and therapeutic properties.

The sulfuric acid used is usually 95-98% FCC Grade (about 35-37 N). The amount of concentrated sulfuric acid can range from about 0.05 M to about 18 M (about 0.1 N to about 36 N), preferably from about 1 M to about 5 M. It is application specific. The term “M” used denotes molar or moles per liter.

Normally, a slurry of finely ground calcium hydroxide suspended in water (about 50% of w/v) is the preferred way of introducing the calcium hydroxide, in increments, into the stirring solution of sulfuric acid, with or without the presence of calcium sulfate. Ordinarily, the reaction is carried out below 40° C., preferably below room temperature, and more preferably below 10° C. The time to add calcium hydroxide can range from about 1 hour to about 4 hours. The agitation speed can vary from about 600 to about 700 rpm or higher. After the mixing, the mixture is filtered through a 5 micron filter. The filtrate is then allowed to sit overnight and the fine sediment is removed by decantation.

The calcium hydroxide used is usually FCC Grade of about 98% purity. For every mole of concentrated acid, such as sulfuric acid, the amount, in mole, of calcium hydroxide used is application specific and ranges from about 0.1 to about 1.

The optional calcium carbonate is normally FCC Grade having a purity of about 98%. When used with calcium hydroxide as described above, for every mole of concentrated acid, such as sulfuric acid, the amount, in mole, of calcium carbonate ranges from about 0.001 to about 0.2, depending on the amount of calcium hydroxide used.

The optional carbon dioxide is usually bubbled into the slurry containing calcium hydroxide at a speed of from about 1 to about 3 pounds pressure. The carbon dioxide is bubbled into the slurry for a period of from about 1 to about 3 hours. The slurry is then added to the reaction vessel containing the concentrated sulfuric acid.

Another optional ingredient is calcium sulfate, a Group IIA salt of a dibasic acid. Normally, dihydrated calcium sulfate is used. As used in this application, the phrase “calcium sulfate,” or the formula “CaSO₄,” means either anhydrous or hydrated calcium sulfate. The purity of calcium sulfate (dihydrate) used is usually 95-98% FCC Grade. The amount of calcium sulfate, in moles per liter of concentrated sulfuric acid ranges from about 0.005 to about 0.15, preferably from about 0.007 to about 0.07, and more preferably from about 0.007 to about 0.04. It is application specific.

In the event that CaSO₄ is used for the reaction by adding it to the solution of concentrated H₂SO₄, the amount of CaSO₄, in grams per liter of solution based on final volume, has the following relationship:

| Final AGIIS Acid Normality N | Amount of CaSO₄ in g/l |
|---|---|
| 1-5 | 5 |
| 6-10 | 4 |
| 11-15 | 3 |
| 16-20 | 2 |
| 21-36 | 1 |

The AGIIS obtained could have an acid normality range of from about 0.05 to about 31; the pH of lower than 0; boiling point of from about 100 to about 106° C.; freezing point of from about −8° C. to about 0° C.

AGIIS obtained from using the reaction of H₂SO₄/Ca(OH)₂/CaSO₄ had the following analyses (average):

AGIIS with Final Acid Normality of 1.2 N, pH of −0.08

H₃O⁺, 2.22%; Ca, 602 ppm; SO₄, 73560 ppm; K, 1.36 ppb; impurities of 19.68 ppm, and neither Na nor Mg was detected.

AGIIS with Final Acid Normality of About 29 N, pH of About −1.46

H₃O⁺, 30.68%; Ca, 52.9 ppm; SO₄, 7356000 ppm; K, 38.02 ppb; and neither Na nor Mg was detected.

Aqueous solutions of other alkalis or bases, such as Group IA hydroxide solution or slurry and Group IIA hydroxide solution or slurry can be used. Groups IA and IIA refer to the two Groups in the periodical table. The use of Group IIA hydroxide is preferred. Preferably, the salts formed from using Group IIA hydroxides in the reaction are sparingly soluble in water. It is also preferable to use only Group IIA hydroxide as the base without the addition of Group IA hydroxide.

After the reaction, the resultant concentrated acidic solution with a relatively low pH value, typically below pH 1, can then be diluted with de-ionized water to the desired pH value, such as pH of about 1 or about 1.8.

As discussed above, AGIIS has relatively less dehydrating properties (such as charring sucrose) as compared to the saturated solution of CaSO₄ in the same concentration of H₂SO₄. Further, the stability and non-corrosive nature of the AGIIS of the present invention can be illustrated by the fact that a person can put his or her hand into this solution with a pH of less than 0.5 and, yet, his or her hand suffers no irritation, and no injury. If, on the other hand, one places his or her hand into a solution of sulfuric acid of pH of less than 0.5, an irritation would occur within a relatively short span of time. A solution of 27 N of sulfuric acid saturated with calcium sulfate will cause chemical burn to a human skin after a few seconds of contact. In contrast, AGIIS solution of the same normality would not cause chemical burn to a human skin even after in contact for 5 minutes. The AGIIS does not seem to be corrosive when being brought in contact with the environmental protective covering of plants (cuticle) and animals (skin). AGIIS has low volatility at room temperature and pressure. Even as concentrated as 27 N, the AGIIS has no odor, does not give off fumes in the air, and is not irritating to a human nose when one smells this concentrated solution.

In order to prepare one embodiment of the current invention, the blend of organic acids with AGIIS, it is preferred that water is added first, if the formulation requires it. Next, the organic acid, or mixture of organic acids, is added to the water. The AGIIS, prepared according to the description above, is then added and blended into the solution. Finally, the additives are mixed in. This is the preferred general order of steps, but this procedure may be altered as needed. For example, the organic acids or the AGIIS may be added prior to the water. If a salt is to be added as an additive, including inorganic or organic metal salts or base material, it is preferred that it is added prior to the addition of the AGIIS. Peroxides are preferably added immediately prior to use. If alcohols are required, these should be added last. If the addition of a surfactant is also required, the alcohol should be added after the surfactant in order to reduce foam. Mixing times will vary depending on the product. Continuous mixing is preferred until the last additive is thoroughly dispersed. Furthermore, if filtration is required, the additives should be added and mixed into the final product, after filtration. Cooling and heating are not required, but may be done as needed.

Yet another acidulant of the present invention is a composition of a highly acidic metalated organic acid (“HAMO”). The composition may have a suspension of very fine particles, and it has a monovalent or a polyvalent cation, an organic acid, and an anion of a regenerating acid, such as the anion of a strong oxyacid. The term “highly acidic” means the pH is in the acidic region, below at least about 4, preferably 2.5. HAMO of the present invention is less corrosive to a ferrous metal than a solution of a mineral acid having the same acidic pH value as that of the acidic composition. HAMO is also more biocidal than a mixture of the organic acid and a metal salt of the organic acid which mixture having the same acid normality value as that of the acidic composition.

Broadly, one way HAMO can be prepared is by mixing the following ingredients: (1) at least one regenerating acid; (2) at least one metal base; and (3) at least one organic acid, wherein the equivalent amount of the regenerating acid is in excess of the equivalent amount of the metal base. The equivalent amount of the metal base should be about equal to that of the organic acid. Instead of using a metal base and an organic acid, a metal salt of the organic acid can be used in place of the metal base and the organic acid. The insoluble solid is removed by any conventional method, such as sedimentation, filtration, or centrifugation.

Generally, HAMO can be prepared by blending or mixing the necessary ingredients in at least the following manners:

| | |
|---|---|
| 1. | Regenerating acid + (metal base + organic acid); |
| 2. | Regenerating acid + (metal base + salt of organic acid); |
| 3. | (Regenerating acid + salt of organic acid) + base; and |
| 4. | Regenerating acid + salt of organic acid. |

The parenthesis in the above scheme denotes “pre-mixing” the two ingredients recited in the parenthesis. Normally, the regenerating acid is added last to generate the HAMO. Although each of the reagents is listed as a single reagent, optionally, more than one single reagent, such as more than one regenerating acid or organic acid, can be used in the current invention. The number of equivalents of the regenerating acid must be larger than the number of equivalents of the metal base, or those of the metal salt of the organic acid. When the organic acid is an amino acid, which, by definition contains at least one amino group, then the number of equivalents of the regenerating acid must be larger than the total number of equivalents of the metal base, or metal salt of the organic acid, and the “base” amino group of the amino acid. Thus, the resultant highly acidic metalated organic acid is different from, and not, a buffer. See, “Highly Acidic Metalated Inorganic Acid,” U.S. application Ser. No. 09/655,131, filed Sep. 5, 2000, the entire content of which is hereby incorporated by reference.

As used herein, a regenerating acid is an acid that will “re-generate” the organic acid from its salt. Examples of a regenerating acid include a strong binary acid, a strong oxyacid, and others. A binary acid is an acid in which protons are directly bound to a central atom, that is (central atom)-H. Examples of a binary acid include HF, HCl, HBr, H₁, H₂S and HN₃. An oxyacid is an acid in which the acidic protons are bound to oxygen, which in turn is bound to a central atom, that is (central atom)-O—H. Examples of oxyacid include acids having Cl, Br, Cr, As, Ge, Te, P, B, As, I, S, Se, Sn, Te, N, Mo, W, or Mn as the central atom. Some examples include H₂SO₄, HNO₃, H₂SeO₄, HClO₄, H₃PO₄, and HMnO₄. Some of the acids (e.g. HMnO₄) cannot actually be isolated as such, but occur only in the form of their dilute solutions, anions, and salts. A “strong oxyacid” is an oxyacid, which at a concentration of 1 molar in water gives a concentration of H₃O⁺ greater than about 0.8 molar.

The regenerating acid can also be an acidic solution of sparingly-soluble Group IIA complexes (“AGIIS”).

To create the blend of organic acids and HAMO, the general formulation described above should be followed. The organic acids may be added at any time during the formulation process. HAMO can be formed in the presence of an organic acid, using, for example, propionic acid, calcium lactate, and AGIIS. Alternatively, the organic acids can be added to the final product or premixed with the regenerating acid and then added to the metal salt or base. If a salt is to be added as an additive, including inorganic or organic metal salts or base material, it can be added at any time during the process. However, extra mixing and filtration could be required. If surfactants are to be used, it is preferred that they are added to the final filtered product and mixed until dissolved. Alcohols, if required, should be added to the product after filtration. If a surfactant and an alcohol are used, the alcohol can be added during the mixing of the surfactant to control the foam produced. Peroxides should be mixed in after the product is filtered, but it is highly preferred that they are mixed into the final product immediately prior to use.

The acidulant HAMMIA has an acidic pH, and can be isolated from a mixture prepared by mixing ingredients comprising a salt of phosphoric acid, and a preformed, or in-situ generated, solution or suspension of AGIIS, wherein the solution or suspension of AGIIS is in an amount sufficient to render the acidic pH of the composition to be less than about 2. Another embodiment of HAMMIA involves a composition having an acidic pH, which is isolated from a mixture prepared by mixing ingredients comprising a salt of phosphoric acid, and a preformed, or in-situ generated, solution or suspension of AGIIS, wherein the solution or suspension of AGIIS is in an amount in excess of the amount required to completely convert the salt of phosphoric acid to phosphoric acid.

To create a blend of organic acids with HAMMIA, in accordance with another embodiment of the current invention, the organic acids may be added at any time during the formation of HAMMIA. The HAMMIA regeneration can take place in the presence of the organic acid or acids. If a salt is to be added as an additive, including inorganic or organic metal salts or base material, it can be added at any time during the process. However, extra mixing and filtration could be required. If surfactants are to be used and the product requires filtration, it is preferred that they are added to the final filtered product and mixed until dissolved. If no filtration is required, the addition of the surfactant should be incorporated into the last step of the process. Alcohols, if required, should be added to the product after filtration. If a surfactant and an alcohol are used, the alcohol can be added during the mixing of the surfactant to control the foam produced. Peroxides should be mixed in after the product is filtered, but it is highly preferred that they are mixed into the final product immediately prior to use.

Strong inorganic acids which may be used as the acidulant, either alone or in combination, include sulfuric acid, phosphoric acid, and hydrochloric acid. Alternatively, acidic salts may be used instead of a strong inorganic acid. Particularly, monobasic salts of phosphoric acid and group I bisulfate salts may be used. The most preferred acidic salts are Group I or II monobasic salts of phosphoric acid. The acidic salts can also be produced by partially neutralizing the acid with an appropriate basic material.

In order to prepare the blend of organic acids with a strong inorganic acid, it is preferred that water is added first, if the formulation requires it. Next, the organic acid, or mixture of organic acids, is added to the water. The inorganic acid is then added and blended into the solution. Finally, the additives are mixed in. This is the preferred general order of steps, but this procedure may be altered as needed. For example, the organic or inorganic acids may be added prior to the water. If an acidic salt is to be used in place of the inorganic acid, it can be directly mixed in with the organic acids. If a salt is to be added as an additive, including inorganic or organic metal salts or base material, it is preferred that it is added prior to the addition of the inorganic acid. Peroxides are preferably added immediately prior to use. If alcohols are required, these should be added last. If the addition of a surfactant is also required, the alcohol should be added after the surfactant in order to reduce foam. Mixing times will vary depending on the product. Continuous mixing is preferred until the last additive is thoroughly dispersed. Furthermore, if filtration is required, the additives should be added and mixed into the final product, after filtration. Cooling and heating are not required, but may be done as needed.

The composition of the present invention was found to be a “preservative.” The composition is less corrosive; however, it can create an environment where destructive micro-organisms cannot live and propagate, thus prolonging the shelf-life of the product. The utility of this method of preservation is that additional chemicals do not have to be added to the food or other substance to be preserved because the inherent low pH of the mixture is preservative. Since preservative chemicals do not have to be added to the food substance, taste is improved and residues are avoided. Organoleptic testing of a number of freshly preserved and previously preserved food stuffs have revealed the addition of composition improves taste and eliminates preservative flavors. The term “organoleptic” means making an impression based upon senses of an organ or the whole organism. Use of the composition both as a preservative and taste enhancer for food will produce a safer and more desirable product with extended shelf life. It can also be used as an ingredient to adjust product pH

The blended acidic solution effectively eliminates the presence of pathogenic microorganisms in a food product. “Pathogenic microorganisms” are defined as biological organisms which contaminate the environment, or produce harmful contaminating substances, thus making the environment hazardous. Pathogenic microorganisms may include microbes, molds, and other infectious matter. Microbes are minute organisms including spirochetes, bacteria, rickettsiae, and viruses. Pathogenic microorganisms associated with meat products may include E. coli, L. monocytogenes, Staphylococcus, Campylobacter jejuni, Salmonella, Clostridium perfringes, Toxoplasma gondii, and Botulism. The solution has been shown to be highly effective at inhibiting the growth of pathogenic microorganisms and particularly L. monocytogenes.

General examples of a food product include beverages, food additives, beverage additives, food supplements, beverage supplements, seasonings, spices, flavoring agents, stuffings, sauces, food dressings, dairy products, pharmaceuticals, biological products, and others. The food product can be of plant origin, animal origin, or synthetic. If the food product is of animal origin, it may be an animal prior to slaughter, an animal carcass prior to division, a divided and processed animal carcass, a dried animal product, a smoked animal product, a cured animal product, or an aged animal product. Unprocessed animal carcasses have been safely sterilized through contact with the solution. The food product may also be a RTE food product. The acidic solution is particularly effective at eliminating pathogenic microorganisms in RTE meat products without affecting the taste. RTE food products are defined as those food products which have been fully cooked and/or may be eaten immediately after removal from any packaging materials, such as frankfurters, lunchmeats, cooked ham, smoked fish, raw fish, and other prepared beef, pork, poultry, and seafood products.

Contacting a food product with the acidic solution may be done through one of several different methods. The solution may be sprayed onto the product. Alternatively, the product may be dipped into the solution. The solution may also be heated and fogged onto either the food product or the packaging material or both. Other methods of application which effectively contact the product with the solution may be used as well.

### EXAMPLE 1

### AGIIS Having an Acid Normality of 1.2 to 1.5 Prepared by the Method of H₂SO₄/Ca(OH)₂

An amount of 1055 ml (19.2 moles, after purity adjustment and taking into account the amount of acid neutralized by base) of concentrated sulfuric acid (FCC Grade, 95-98% purity) was slowly added with stirring, to 16.868 L of RO/DI water in each of reaction flasks a, b, c, e, and f. The amount of water had been adjusted to allow for the volume of acid and the calcium hydroxide slurry. The mixture in each flask was mixed thoroughly. Each of the reaction flasks was chilled in an ice bath and the temperature of the mixture in the reaction flask was about 8-12° C. The mixture was continuously stirred at a rate of about 700 rpm.

Separately, a slurry was made by adding RO/DI water to 4 kg of calcium hydroxide (FCC Grace, 98% purity) making a final volume of 8 L. The mole ratio of calcium hydroxide to concentrated sulfuric acid was determined to be 0.45 to 1. The slurry was a 50% (w/v) mixture of calcium hydroxide in water. The slurry was mixed well with a high-shear-force mixer until the slurry appeared uniform. The slurry was then chilled to about 8-12° C. in an ice bath and continuous stirred at about 700 rpm.

To each of the reaction flasks was added 150 ml of the calcium hydroxide slurry every 20 minutes until 1.276 L (i.e. 638 g dry weight, 8.61 moles, of calcium hydroxide) of the slurry had been added to each reaction vessel. The addition was again accompanied by efficient mixing at about 700 rpm.

After the completion of the addition of the calcium hydroxide to the reaction mixture in each reaction vessel, the mixture was filtered through a 5-micron filter.

The filtrate was allowed to sit for 12 hours, the clear solution was decanted to discard any precipitate formed. The resulting product was AGIIS having an acid normality of 1.2-1.5.

### EXAMPLE 2

### AGIIS Having an Acid Normality of 2 Prepared by the Method of H₂SO₄/Ca(OH)₂/CaSO₄

For the preparation of 1 L of 2 N AGIIS, an amount of 79.5 ml (1.44 moles, after purity adjustment and taking into account the amount of acid to be neutralized by base) of concentrated sulfuric acid (FCC Grade, 95-98% purity) was slowly added, with stirring, to 854 ml of RO/DI water in a 2 L reaction flask. Five grams of calcium sulfate (FCC Grade, 95% purity) was then added slowly and with stirring to the reaction flask. The mixture was mixed thoroughly. At this point, analysis of the mixture would usually indicate an acid normality of 2.88. The reaction flask was chilled in an ice bath and the temperature of the mixture in the reaction flask was about 8-12° C. The mixture was continuously stirred at a rate of about 700 rpm.

Separately, a slurry was made by adding 50 ml of RO/DI water to 33.26 g (0.44 mole, after purity adjustment) of calcium hydroxide (FCC Grace, 98% purity) making a final volume of 66.53 ml. The mole ratio of calcium hydroxide to concentrated sulfuric acid was determined to be 0.44 to 1. The slurry was mixed well with a high-shear-force mixer until the slurry appeared uniform. The slurry was then chilled to about 8-12° C. in an ice bath and continuous stirred at about 700 rpm.

The slurry was then slowly added over a period of 2-3 hours to the mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

The filtrate was allowed to sit for 12 hours, and the clear solution was then decanted to discard any precipitate formed. The resulting product was AGIIS having an acid normality of 2.

### EXAMPLE 3

### AGIIS Having an Acid Normality of 12 Prepared by the Method of H₂SO₄/Ca(OH)₂/CaSO₄

For the preparation of 1 L of 12 N AGIIS, an amount of 434 ml (7.86 moles, after purity adjustment and taking into account amount of acid neutralized by base) of concentrated sulfuric acid (FCC Grade, 95-98% purity) was slowly added, with stirring, to 284.60 ml of RO/DI water in a 2 L reaction flask. Three grams of calcium sulfate (FCC Grade, 95% purity) was then added slowly and with stirring to the reaction flask. The mixture was mixed thoroughly. The reaction flask was chilled in an ice bath and the temperature of the mixture in the reaction flask was about 8-12° C. The mixture was continuously stirred at a rate of about 700 rpm.

Separately, a slurry was made by adding 211 ml of RO/DI water to 140.61 g (1.86 moles, after purity adjustment) of calcium hydroxide (FCC Grace, 98% purity) making a final volume of 281.23 ml. The mole ratio of calcium hydroxide to concentrated sulfuric acid was determined to be 0.31. The slurry was mixed well with a high-shear-force mixer until the slurry appeared uniform. The slurry was then chilled to about 8-12° C. in an ice bath and continuous stirred at about 700 rpm.

The slurry was then slowly added over a period of 2-3 hours to the acid mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

The filtrate was allowed to sit for 12 hours, and the clear solution was then decanted to discard any precipitate formed. The resulting product was AGIIS having an acid normality of 12.

### EXAMPLE 4

### Formation of HAMO from Glycolic Acid

1 kg of glycolic acid was dissolved into 1.5 L water. 482 g of calcium hydroxide was slowly added to the solution at which time the entire slurry solidified. 2.75 L of 4.8 N AGIIS was added in 50-ml intervals. The final volume was 5.0 L. The final pH was 1.0-1.5.

### EXAMPLE 5

### General Method for the Formation of an Amino Acid HAMO Using 1.2M Sulfuric Acid as Regenerating Acid

A solution of dilute sulfuric acid approximately 1.2 M in water was prepared by weighing 111.64 g of concentrated (96-98%) sulfuric acid and diluting with water to 1000 mL.

The amino acid or its hydrochloride salt (0.025-0.1 mole) was weighed into an Erlenmeyer flask and approximately 10 mole equivalents of water was added. Solid calcium hydroxide (7.40 g, 0.10 mol) was added to the flask and the mixture was stirred at room temperature for 30 minutes to ensure complete reaction. The dilute sulfuric acid (84.0 mL, 0.10 moles H₂SO₄) was then added to the mixture. The mixture was filtered through a medium-porosity glass frit to give the HAMO. The total acid content of the HAMO was determined by titration against standard tris-(hydroxymethyl)aminomethane (“THAM”).

HAMOs Prepared From Amino Acids by This Method

| Amino Acid | Moles of Amino Acid | [H₃O+] in HAMO* |
|---|---|---|
| L-glutamine | 0.10 | 0.133 M¹ |
| L-phenylalanine | 0.05 | 0.185 M² |
| L-asparagine | 0.10 | 0.070 M³ |
| L-histidine.HCl | 0.10 | 0.57 M |
| L-glutamic acid | 0.10 | 0.124 M⁴ |
| L-aspartic acid | 0.10 | 0.170 M⁵ |
| L-lysine.HCl | 0.10 | 0.56 M⁶ |
| L-leucine | 0.10 | 0.173 M⁷ |
| L-alanine | 0.10 | 0.099 M⁸ |
| L-isoleucine | 0.02 | 0.351 M⁹ |
| L-serine | 0.025 | 0.274 M |

*Molarity
¹Ca, 844 ppm; SO₄, 3,120 ppm
²Ca, 390 ppm; SO₄, 13,900 ppm.
³Ca, 625 ppm; SO₄, 3,120 ppm.
⁴Ca, 646 ppm; SO₄, 5,120 ppm.
⁵Ca, 1,290 ppm; SO₄, 3,850 ppm.
⁶Ca, 1,910 ppm; SO₄, 7,560 ppm.
⁷Ca, 329 ppm; SO₄, 315,000 ppm.
⁸Ca, 1,230 ppm; SO₄, 4,480 ppm.
⁹Ca, 749 ppm; SO₄, 314,000 ppm.

HAMOs Prepared With Amino Acids and Metal Bases*

| Amino Acid | Metal Base | Regenerating Acid |
|---|---|---|
| L-glutamine | Ca(OH)2 | H₂SO₄ |
| L-phenylalanine | Ca(OH)₂ | H₂SO₄ |
| L-asparagine | Ca(OH)₂ | H₂SO₄ |
| L-histidine.HCl | Ca(OH)₂ | H₂SO₄ |
| L-glutamic acid | Ca(OH)₂ | H₂SO₄ |
| L-aspartic acid | Ca(OH)₂ | H₂SO₄ |
| L-lysine.HCl | Ca(OH)₂ | H₂SO4 |
| L-leucine | Ca(OH)₂ | H₂SO₄ |
| L-alanine | Ca(OH)₂ | H₂SO₄ |
| L-isoleucine | Ca(OH)₂ | H₂SO₄ |
| L-serine | Ca(OH)₂ | H₂SO₄ |
| glycine | Ca(OH)₂ | H₂SO₄ |
| L-glutamic acid | CuCO₃.Cu(OH)₂ | H₃PO₄ |
| L-glutamic acid | 2CoCO₃.3Co(OH)₂ | H₃PO₄ |
| L-glutamic acid | MnCO₃ | H₃PO₄ |

*Each of the product has a pH of lower than about 3.

### EXAMPLE 6

### Formation of a Phosphoric Acid HAMMIA Using Preformed AGIIS

The phosphate salt of a divalent metal chosen from List A below (1.00 mole equivalents) is suspended in sufficient deionized water to make a final volume of 625 mL per mole of phosphate ions. The mixture may be sonicated or heated as necessary to aid solubilization of the sparingly soluble phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂
Ca₃(PO₄)₂, CaHPO₄, Ca(H₂PO₄)₂
Mn₃(PO₄)₂, MnHPO₄, Mn(H₂PO₄)₂
Fe₃(PO₄)₂, FeHPO₄, Fe(H₂PO₄)₂
Co₃(PO₄)₂, CoHPO₄, Co(H₂PO₄)₂
Ni₃(PO₄)₂, NiHPO₄, Ni(H₂PO₄)₂
Cu₃(PO₄)₂, CuHPO₄, Cu(H₂PO₄)₂
Zn₃(PO₄)₂, ZnHPO₄, Zn(H₂PO₄)₂

### EXAMPLE 7

### Formation of a Phosphoric Acid HAMMIA Using AGIIS Formed In Situ

A mixture of calcium hydroxide (1.00 mole equivalents) and the phosphate salt of a divalent metal chosen from List A below (1.00 mole equivalents) is suspended in sufficient deionized water to make a final volume of approximately 400 mL per mole of metal ions. The mixture may be sonicated or heated as necessary to aid solubilization of the sparingly soluble metal salts. To this stirred suspension, concentrated sulfuric acid (5.05 mole equivalents of hydrogen ion per mole of phosphate ion) is added in 10-mL aliquots with the pH being monitored after each addition. The addition of acid may be discontinued when the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂
Ca₃(PO₄)₂, CaHPO₄, Ca(H₂PO₄)₂
Mn₃(PO₄)₂, MnHPO₄, Mn(H₂PO₄)₂
Fe₃(PO₄)₂, FeHPO₄, Fe(H₂PO₄)₂
Co₃(PO₄)₂, CoHPO₄, Co(H₂PO₄)₂
Ni₃(PO₄)₂, NiHPO₄, Ni(H₂PO₄)₂
Cu₃(PO₄)₂, CuHPO₄, Cu(H₂PO₄)₂
Zn₃(PO₄)₂, ZnHPO₄, Zn(H₂PO₄)₂

### EXAMPLE 8

### Formation of a Phosphoric Acid HAMMIA Containing a Monovalent Metal Using Pre-Formed AGIIS

The phosphate salt of a divalent metal chosen from List A below (1.00 mole equivalents) and the phosphate salt of a monovalent metal chosen from List B below (<1.00 mole equivalents) is suspended in sufficient deionized water to make a final volume of 625 mL per mole of phosphate ions. The mixture may be sonicated or heated as necessary to aid solubilization of the sparingly soluble divalent metal phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

| List A: | List B: |
|---|---|
| Divalent Metal Phosphate Salts | Monovalent Metal Phosphate Salts |
| Mg₃(PO₄)₂, MgHPO₄, Mg(H₂PO₄)₂ | Li₃PO₄, Li₂HPO₄, LiH₂PO₄ |
| Ca₃(PO₄)₂, CaHPO₄, Ca(H₂PO₄)₂ | Na₃PO₄, Na₂HPO₄, NaH₂PO₄ |
| Mn₃(PO₄)₂, MnHPO₄, Mn(H₂PO₄)₂ | K₃PO₄, K₂HPO₄, KH₂PO₄ |
| Fe₃(PO₄)₂, FeHPO₄, Fe(H₂PO₄)₂ | |
| Co₃(PO₄)₂, CoHPO₄, Co(H₂PO₄)₂ | |
| Ni₃(PO₄)₂, NiHPO₄, Ni(H₂PO₄)₂ | |
| Cu₃(PO₄)₂, CuHPO₄, Cu(H₂PO₄)₂ | |
| Zn₃(PO₄)₂, ZnHPO₄, Zn(H₂PO₄)₂ | |

### EXAMPLE 9

### Formation of Acidic Compositions Containing Organic Acids Blended with AGIIS

One solution was prepared as a ground beef additive. 100 ml 5 N AGIIS was slowly added into a container followed by 100 ml lactic acid. 800 ml water was slowly mixed into the solution. The solution was allowed to evenly mix.

One solution was prepared for the treatment of cooked ham, as well as frankfurters. 1.535 kg lactic acid was added to a container followed by 1.218 kg propionic acid. 908 ml water was slowly mixed into the solution. 0.090 kg disodium phosphate was slowly mixed into the solution and continually mixed until completely dissolved. 0.318 kg 5 N AGIIS was evenly mixed into the solution. The result was a concentrated product (1:2). Dilution yielded a solution around 100,000 ppm lactic acid and 100,000 ppm propionic acid at a pH around 1.5.

Seven additional solutions were prepared for the treatment of frankfurters. For the first solution, 1.535 kg lactic acid was slowly mixed with 2.126 kg water. 0.093 kg disodium phosphate was slowly added into the mixture and mixed until dissolved. 0.3180 kg 5 N AGIIS was slowly added. The total solution was allowed to evenly mix. The result was a concentrated product (1:2) which when diluted yielded a mixture around 100,000 ppm lactic acid at pH 1.5.

For the second frankfurter solution, 1.535 Kg lactic acid was added to a container. 2.124 kg water was slowly added and the solution was evenly mixed. 0.090 kg disodium phosphate was added and allowed to mix until the salt was dissolved. 0.3180 kg 5 N AGIIS was slowly added and mixed into solution. 1.90 g dodecylbenzene sodium sulfonate was added. The solution was allowed to mix until all ingredients were dissolved. The result was a concentrated product (1:2) which yielded a diluted product around 100,000 ppm lactic acid with a pH 1.5.

For the third frankfurter solution, 1.535 kg lactic acid was added to a container. 2.121 kg water was slowly added and the solution was allowed to evenly mix. 0.090 kg disodium phosphate was added and allowed to mix until dissolved. 0.3180 kg 5 N AGIIS was added and evenly mixed into solution. 4.32 g 200 proof ethanol was added and mixed into solution. The result was a concentrated product (1:2) which upon dilution yielded a mixture around 100,000 ppm lactic acid and a pH of 1.5.

For the fourth frankfurter solution, 1.535 kg lactic acid was added to a container. 2.124 kg water was slowly mixed in. 0.090 kg disodium phosphate was slowly added and allowed to mix until completely dissolved. 0.318 kg 5 N AGIIS was slowly mixed into the solution. 2.0 g DBSA was added and allowed to mix until dissolved. The result was a concentrated solution (1:2) which upon dilution yielded a mixture around 100,000 ppm lactic acid with a pH of 1.5.

For the fifth frankfurter solution, 1.535 kg lactic acid was slowly added to a container. 2.110 kg water was slowly mixed in to the solution. 0.090 kg disodium phosphate was added to the solution and allowed to mix until completely dissolved. 0.318 kg 5 N AGIIS was evenly mixed into the solution. 2.0 g dodecylbenzene sodium sulfonate was added and allowed to dissolve followed by 10 g polypropylene glycol 2000 and 3.2 g oleic acid. The result was a concentrated product (1:2) which had to be thoroughly mixed before dilution. Dilution yielded a solution of around 100,000 ppm lactic acid and a pH of 1.5.

For the sixth frankfurter solution, 3.645 kg water was added to a container. 2.0 g dodecylbenzene sodium sulfonate was added into the solution and allowed to dissolve. 10 g polypropylene 2000 was added allowed to mix followed by 3.2 g oleic acid. 140 g 5 N AGIIS 50 was slowly mixed into the solution. The result was a concentrated solution (1:2). The concentrate was thoroughly mixed prior to dilution. Dilution yielded a pH of 1.5.

For the seventh frankfurter solution, 1.535 kg lactic acid was added to a container. 2.110 kg water was slowly mixed into the solution. 0.090 kg disodium phosphate was added and allowed to mix until completely dissolved. 0.318 kg AGIIS 5 N was slowly mixed into the solution. 2.0 g dodecylbenzene sulfonic acid was added and allowed to mix until dissolved. 10 g polypropylene glycol 2000 was added followed by 3.2 g oleic acid. The solution was allowed to evenly mix. The result was a concentrated product (1:2). The concentrate had to be thoroughly mixed prior to dilution. Dilution yielded a mixture around 100,000 ppm lactic acid with a pH of 1.5.

One solution was prepared for the treatment of fish fillets. 750 ml of HAMO, prepared using gluconic acid, was added to a container. 250 ml 5 N AGIIS was slowly mixed into the solution. The total solution was allowed to evenly mix.

An additional solution was prepared by adding 939 ml 5 N AGIIS to a container. 61 ml butyric acid was slowly mixed into the solution. The solution was allowed to evenly mix.

Three solutions were prepared using citric acid and 5 N AGIIS. The first used 900 ml 5 N AGIIS, with 100 g of citric acid slowly mixed in. The second solution was composed of 800 ml 5 N AGIIS, with 200 g citric acid slowly mixed in. The third solution was composed of 700 ml 5 N AGIIS, with 300 g citric acid slowly mixed in. Each solution was mixed until completely dissolved.

### EXAMPLE 10

### Formation of Acidic Compositions Containing Organic Acids Blended with HAMO

Three solutions were prepared for use in the treatment of frankfurters. For the first solution, 65 g calcium lactate was added to a container. 800 ml water was added and the solution was mixed. 50 ml lactic acid was slowly mixed into the solution. 95 ml 5 N AGIIS was slowly added. The solution was mixed thoroughly. The precipitate was removed by centrifugation. The result was a solution with a pH around 1.5 and a lactate concentration around 100,000 ppm.

For the second frankfurter solution, 140 ml sodium lactate (60%) was added to a container. 50 ml lactic acid was slowly mixed into the container. 700 ml water was added and the solution was allowed to mix evenly. 415 ml 5 N AGIIS was slowly added to the mixture. The result was a solution with 100,000 ppm lactate and a ph of 1.5. For the third frankfurter solution, 89 g sodium lactate (60%) was added to a container. 252 ml lactic acid was added along with 605 ml water. The solution was allowed to mix evenly. 128 ml 5 N AGIIS was added with mixing. The result was a concentrated solution (1:2) which upon dilution yielded a product with around 100,000 ppm lactic acid at a pH around 1.5.

An additional solution was prepared by adding 225 kg water to a mixing vessel. The mixing was continuous until the batch was complete. 315 kg gluconic acid was added to the mix vessel. 28.8 kg calcium hydroxide was added. The amount of calcium hydroxide was not enough to completely convert all of the gluconic acid to its calcium salt, so there was excess gluconic acid in solution. 262.5 kg 5 N AGIIS was slowly mixed into the solution, followed by 55.2 kg sulfuric acid. The precipitate was removed by filtration.

### EXAMPLE 11

### Formation of Acidic Composition Containing Organic Acids Blended with HAMMIA

The HAMMIA solution was prepared by adding 500 g of calcium dihydrogen phosphate to a container. 1 L of deionized water was mixed into the container. The solution was allowed to evenly mix. 1.2 L 5 N AGIIS was slowly mixed into the solution. The solution was allowed to mix and equilibrate for 12 hours. The precipitate was removed by centrifugation. The result was a HAMMIA solution with a pH less than 0.0. The blended solution was prepared by adding 0.138 kg lactic acid to a container. 785 ml deionized water was mixed into the solution. 30 g disodium phosphate was added to the solution and allowed to mix until completely dissolved. The pH of the solution was about 3.0. 220 ml of the prepared HAMMIA solution was then added slowly under constant mixing. The end result was a solution with around 100,000 ppm lactic acid with a pH around 1.5.

### EXAMPLE 12

### Formation of Acidic Compositions Containing Organic Acids Blended with Strong Inorganic Acids

A first solution was prepared by adding 775 ml water to a container. 845 ml gluconic acid was slowly mixed into the solution. 96 g of calcium hydroxide was slowly added to the solution under constant mixing. The calcium hydroxide added was not enough to convert all of the organic acid to its calcium salt, so there was excess organic acid present. 125 ml phosphoric acid was added to the solution. 700 ml 5 N AGIIS was slowly mixed into the solution. The solution was allowed to evenly mix. The precipitate was removed by centrifugation.

A second solution was prepared by adding 0.52 kg lactic acid to a container. 3.0 L deionized water was mixed into the solution. 0.030 kg disodium phosphate was slowly added and allowed to mix until completely dissolved. 80 ml concentrated phosphoric acid (85%) was slowly mixed into the solution. The end result was a solution of about 100,000 ppm lactic acid with a pH around 1.5.

A third solution was prepared by adding 1.535 kg lactic acid to a container. 1.613 L deionized water was slowly mixed into the solution. 0.090 kg disodium phosphate was slowly added into the container and allowed to mix until completely dissolved. 240 ml concentrated phosphoric acid (85%) was slowly mixed into the solution. The final solution was allowed to mix for 5 minutes. The result was a concentrated solution which upon dilution yielded a pH around 1.5 with 100,000 ppm lactic acid.

A fourth solution was prepared by adding 0.52 kg lactic acid to a container. 3 L deionized water was slowly mixed into the solution. 16 ml of concentrated phosphoric acid (85%) was slowly mixed into the solution. The solution was allowed to evenly mix. The result was a solution with 100,000 ppm lactic acid with a pH around 1.5.

A fifth solution was prepared by adding 1.535 kg lactic acid to a container. 1895 ml deionized water was added to the container and allowed to evenly mix. 48 ml concentrated phosphoric acid (85%) was slowly mixed into the solution. The solution was allowed to mix for 5 minutes. The result was a concentrated solution which upon dilution yielded a solution around 100,000 ppm lactic acid and a pH around 1.5.

A sixth solution was prepared by adding 100 g citric acid into a container. 0.030 kg disodium phosphate was then added into the container. 3.3 L deionized water was slowly mixed into the container. The solution was allowed to mix until all the ingredients were dissolved. 72 ml 6 N HCl was slowly mixed into the solution. The solution was allowed to mix for 5 minutes after the last addition of HCl. The result was a solution with a final pH around 1.5 and a final concentration of citric acid around 100,000 ppm.

A seventh solution was prepared by adding 1.136 kg propionic acid to a container. 2.513 kg deionized water was slowly mixed into the solution. 0.90 kg disodium phosphate was added to the solution and allowed to mix until completely dissolved. 82 g concentrated sulfuric acid (95%) was slowly mixed into the solution. The solution was allowed to mix for 5 minutes after the last addition of the sulfuric acid. The result was a concentrated product upon dilution yielded a solution with a pH around 1.5 and a concentration of lactic acid around 100,000 ppm.

### EXAMPLE 13

### Formation of Acidic Compositions Containing Organic Acids Blended with Inorganic Salts

A solution was prepared by adding 378 g propionic acid to a container. 3100 ml DI water was added and the solution was allowed to evenly mix. 29 g sodium bisulfate was slowly mixed into the solution. The solution was allowed to mix until the bisulfate was completely dissolved. The result was a solution around 100,000 ppm propionic acid with a final pH around 1.5.

### EXAMPLE 14

### Effects of Acidic Composition Treatment on Cultured L. monocytogenes

Seven acidic composition solutions were prepared according to Table 1 below using the following five ingredients: (1) AGIIS, (2) water, (3) lactic acid, (4) surfactant, and (5) disodiumphosphate. Surfactants used included Barlox, which is an amine oxide manufactured by Ionza, poly sorbate 80 (Tween), and SDS.

TABLE 1

| Solution | AGIIS | Water | Lactic acid | Surfactant | |
|---|---|---|---|---|---|
| No. | (g) | (kg) | (kg) | (g) | Na₂HPO₄(g) |
| 1 | 318 | 2.127 | 1.538 | Barlox 2.6 | 90 |
| 2 | 319.4 | 2.124 | 1.535 | Barlox 0.95 | 94.6 |
| 3 | 318 | 2.1242 | 1.535 | Barlox 1.956 | 90.4 |
| 4 | 318.2 | 2.1242 | 1.5348 | Tween 1.902 | 90.4 |
| 5 | 138 | 2.1246 | 1.5352 | Tween 1.000 | 91.4 |
| 6 | 318.2 | 2.125 | 1.53 | SDS 0.9571 | 90.4 |
| 7 | 318.8 | 2.1254 | 1.5302 | SDS 1.904 | 90.4 |

An overnight culture of L. monocytogenes was prepared. 0.5 mL of this culture was added to eight 10 ml test tubes, seven containing 4.5 ml of solutions 1-7 respectively and an eighth control sample containing 4.5 ml pH 7.38 phosphate buffer. Each tube was mixed well with a pipette, with care being taken to avoid touching the wall of the tube with the pipette. After 30 seconds, the solutions were diluted ten fold using pH 7.38 phosphate buffer. The dilutions were plated onto brain heart infusion agar plates. All plates were kept inverted in a 37° C. incubator for about 24-48 hours. The colonies on the plates were then counted and the CFU's calculated. As shown in Table 2 below, the control sample contained a greater number of L. monocytogenes CFU's by more than five orders of magnitude.

TABLE 2

| Solution No. | CFU L. monocytogenes |
|---|---|
| 1 | 8.00 × 10² |
| 2 | 6.67 × 10² |
| 3 | 7.33 × 10² |
| 4 | 4.00 × 10² |
| 5 | <6.67 × 10¹ |
| 6 | <6.67 × 10¹ |
| 7 | <6.67 × 10¹ |
| Control | 1.53 × 10⁸ |

### EXAMPLE 15

### Treatment of Ready-To-Eat Frankfurters

An acidic composition was used to treat RTE frankfurters. The acidic composition was a propionate into HAMO. The composition was prepared by first adding 1 kg calcium propionate into a contained. 5.5 L deionized water was then slowly stirred into the contained. 300 ml concentrated sulfuric acid was slowly mixed into the solution. The solution was allowed to mix evenly and then filtered using a 5 micron filter bag. The end pH of the solution was around 0.5. The concentration of sulfate was around 3600 ppm and the concentration of propionic acid was around 100,000 ppm.

Twenty-four frankfurters to be used in the study were collected from a production batch under strict sanitary conditions and divided into two groups. The control (C) group consisting of 12 frankfurters were individually placed in a plastic bag such that the frankfurter was completely immersed in a saline solution. The frankfurter was immediately removed, allowed to drip for five (5) seconds and then placed in a bag with two other similarly treated frankfurters. The bag was then vacuum-sealed. Likewise, the treated (T) group consisting of 12 frankfurters were individually placed in a plastic bag such that the frankfurter was completely immersed in the acidic solution. Following treatment each frankfurter was immediately removed, allowed to drip for five (5) seconds and then placed in a bag with two other treated frankfurters.

Untreated and treated frankfurters in packages were stored at 4-8° C. and subjected to microbiologic and organoleptic analysis at two-week intervals. The results of these analyses are described in Table 3 below.

TABLE 3

| Weeks Post- | | |
|---|---|---|
| treatment | Control | Treated |
| Two | Surface of frankfurters exhibited | Frankfurter odor was not |
| | less shine or reflectance. | as intense as that of the |
| | Appearance was paler than | controls. Surface of |
| | treated frankfurters. Odor was | frankfurters shiny. Saline |
| | that of frankfurters. Saline wash | wash was clear. |
| | had a cloudy or turbid | |
| | appearance. | |
| Four | Surface of frankfurters exhibited | No difference in |
| | less shine or reflectance. | frankfurter odor from |
| | Appearance was paler than | controls. Surface of |
| | treated frankfurters. Odor was | frankfurters shiny. |
| | that of frankfurters. Saline wash | Saline wash was clear. |
| | had a cloudy or turbid | |
| | appearance. | |
| Six | Frankfurters became paler, i.e., | Frankfurter odor was |
| | losing color. Surface of | more intense than |
| | frankfurters had a white-like | that of the controls. |
| | consistency that was somewhat | Some color loss relative |
| | slimy. Odor was that of | to four week treated |
| | frankfurters. Saline wash had a | frankfurters was noted. |
| | cloudy or turbid appearance. | Saline wash was clear. |
| Eight | Frankfurters became even paler. | Frankfurter odor was |
| | Surface of frankfurters gained | more intense than |
| | an increasingly white-like | that of the controls. |
| | consistency that was even more | Clean frankfurter surface. |
| | slimy and increased with time. | Color more appealing |
| | The saline wash had a very | than that of the controls. |
| | cloudy or turbid appearance. No | Wash solution clear. |
| | specific odor changes from six | |
| | weeks. | |

Bacteria present on the surface of the control and treated frankfurters were also enumerated by rinsing the control and treated frankfurters with 50 ml of saline. An aliquot of the saline wash from each frankfurter was then serially diluted and a portion of each dilution was plated to determine the number of aerobic bacteria. This determination was similarly made at two-week intervals. At two weeks post-treatment, more than 1×10⁴ bacteria were associated with each control frankfurter, whereas less than 10 organisms were associated with each treated frankfurter. At four weeks, there were more than 1×10⁶ aerobic bacteria associated with each control frankfurter, whereas there remained only less than 10 bacteria associated with each treated frankfurter. After six weeks, enumeration of the bacteria associated with each control frankfurter increased to more than 1×10⁸. The number of bacteria associated with each treated frankfurter increased from less than 10 to about 1×10³ over the four to six week interval. At eight weeks, the number of bacteria associated with the control and treated frankfurters showed little change compared to results observed at six weeks.

Based on the results shown in Table 3, the treated frankfurters clearly exhibited organoleptic properties at eight weeks closer to that of the control frankfurters observed at two weeks. Furthermore, associated bacterial numbers present on treated frankfurters even at eight weeks never approached those observed at two weeks for control frankfurters. It is estimated that bacterial counts in excess of 10⁶ indicate that the product is no longer shelf stable. Therefore, it is apparent that treatment with the acidic solution effectively extends the shelf life of frankfurters without affecting qualities such as taste and smell.

### EXAMPLE 16

### Treatment of Ready-To-Eat Frankfurters Contaminated with L. monocytogenes

An acidic composition was prepared for the treatment of frankfurters contaminated with L. monocytogenes. The composition was a blend of propionic acid and HAMO. The composition was prepared by first adding 7.5 L propionic acid to a 30 gallon container. 40 L deionized water was then slowly mixed into the solution. 3.790 kg of calcium hydroxide was slowly added and mixed into the solution. 3.125 L concentrated sulfuric acid (98%) was slowly added into the solution with constant mixing. The final solution was allowed to mix for 1 hour and then filtered using a 5 micron filter bag. The result was a concentrated solution with a pH of 1.0-1.5. The concentration of propionate was around 366815 ppm and sulfate was around 3788 ppm. Dilution yielded a solution around pH 1.5 and 100,000 ppm propionic acid.

Frankfurters purchased from a local supermarket were divided into two groups. The control (C) group of 8 frankfurters were individually placed on a sheet of aluminum foil and allowed to air dry for 30 minutes. Each control frankfurter was then inoculated with 10 microliters of an overnight culture of L. monocytogenes. Inoculated frankfurters were then air dried for 3 hours. Likewise, the treated (T) group of 8 frankfurters were individually placed on an aluminum foil sheet and air-dried for 30 minutes. Each frankfurter to be treated was then inoculated with 10 microliters of an overnight culture of L. monocytogenes. Inoculated frankfurters were then air dried for 3 hours.

C group frankfurters were individually dipped in 90 ml of saline, immediately removed, allowed to drip for five (5) seconds and placed in a plastic bag. C group frankfurters were then divided into an two groups, designated CRT (room temperature) and CRD (refrigerated or those incubated at 4-8° C.), respectively. Both the CRT and CRD frankfurters were placed in sealed bags and labeled accordingly. T group frankfurters were individually dipped in 90 ml of the prepared acidic solution, immediately removed, allowed to drip for five (5) seconds and placed in a plastic bag. T group frankfurters were then divided into two groups, designated TRT (room temperature) and TRD (refrigerated or those incubated at 4-8° C.), respectively. Both the TRT and TRD frankfurters were then placed in sealed bags and labeled accordingly. CRT and TRT frankfurters were incubated at room temperature for two days, while CRD and TRD frankfurters were incubated at 4-8° C. for seven days.

At the end of the incubation period each frankfurter was immersed in a plastic bag with 50 ml of sterile saline and shaken 100 times. An aliquot of the saline from each frankfurter was serially diluted and plated on L. monocytogenes selective media to enumerate the number of bacteria associated with each frankfurter.

After washing the control frankfurters inoculated with 2.17×10⁷ CFU of L. monocytogenes and incubated for 2 days at room temperature (CRT), more than 1.1×10⁸ CFU/frankfurter could be recovered. In comparison, frankfurters inoculated with the same number of organisms, treated with the acidic solution and incubated under identical conditions to the control frankfurters (TRT) had no associated L. monocytogenes CFU. To further assess the effect of treatment, the washed CRT and TRT frankfurters were then cultured in the presence of L. monocytogenes selective enrichment media at 30° C. overnight. There were a limited number of surviving bacteria associated with TRT frankfurters, indicating a reduction of greater than seven orders of magnitude between the number of CFU in the enrichment culture of the CRT compared to the TRT frankfurters.

After washing the control frankfurters which were inoculated with 2.17×10⁷ CFU of L. monocytogenes and incubated for 7 days at 4-8° C. (CRD), more than 5×10⁶ CFU/frankfurter could be recovered. In comparison, frankfurters inoculated with the same number of organisms, treated with the acidic solution and incubated under identical conditions to the control frankfurters (TRD) had no associated L. monocytogenes CFU. Treatment with the acidic solution appeared to eliminate and/or inhibit all L. monocytogenes organisms that the TRD frankfurters were inoculated with. However, when the washed CRD and TRD frankfurters were cultured in the presence of L. monocytogenes selective enrichment media, at 30° C. overnight, survivors associated with TRD frankfurters were detected. But, like the results obtained when frankfurters were incubated at room temperature, there is a significant difference in the order of magnitude between the CRD and TRD frankfurters. In fact, there is greater than six orders of magnitude between the number of CFU in the enrichment culture from the CRD and TRD frankfurters, respectively. Therefore, it is apparent that treatment with the acidic solution effectively prevents replication of L. monocytogenes on RTE meats such as frankfurters.

### EXAMPLE 17

### Treatment of Ready-To-Eat Frankfurters Contaminated with L. Monocytogenes Using Modified Formula

The same general experimental procedure as described in Example 2 was followed. The acidic composition was prepared by first adding 96.56 ml of an acetic acid HAMO solution into a container. 288.4 ml deionized water was mixed into the solution. 615 ml propionic acid was slowly stirred into the solution. The pH was adjusted using 1 g calcium hydroxide which was stirred into solution. The final solution was then filtered. The final pH was 1.51 and the concentration of propionate was around 90,000 ppm and acetate was around 100,000 ppm.

Frankfurters were inoculated with 1.45×10⁸ CFU of L. monocytogenes. The treated group of frankfurters was individually dipped in the prepared acidic solution for either 30 or 60 seconds. After being incubated overnight at 4° C., more than 4.4×10⁷ CFU/frankfurter could be recovered by washing the control frankfurters. In comparison, frankfurters inoculated with the same number of organisms and treated for 30 seconds or 60 seconds with the acidic solution had 5.65×10³ and 4.45×10² L. monocytogenes CFU/frankfurter associated with them, respectively. Using the modified formula, it can be seen that treatment for 30 seconds reduced the level of L. monocytogenes associated with hot dogs by about 4 logs. Treatment for 60 seconds reduced the associated level by about 5 logs. Therefore, it is apparent that treatment with the modified acidic solution effectively prevents replication of L. monocytogenes on RTE meats such as frankfurters.

### EXAMPLE 18

### Treatment of Ready-To-Eat Chicken and Turkey Frankfurters

An acidic composition was prepared for treatment of chicken and turkey frankfurters. The composition was prepared by first adding 1.535 kg lactic acid to a container followed by 1.218 kg propionic acid. 908 ml water was then slowly mixed into the solution. 0.090 kg disodium phosphate was slowly mixed into the solution and continually mixed until completely dissolved. 0.318 kg 5 N AGIIS was evenly mixed into the solution. The solution was diluted to a 1:2 concentrate (1 part solution to 2 parts water for a total of 3 parts). The final pH of the solution was around 1.5. The concentration of propionate was around 100,000 ppm and lactate was around 100,000 ppm.

Forty-eight chicken and turkey frankfurters were collected from packaged production batches under strict sanitary conditions. The forty-eight chicken and turkey frankfurters were divided into control (C) and treated groups (T). The control (C) group consisting of 24 chickens and 24 turkey frankfurters was subdivided into eight groups and packaged three per plastic bag. The treated (T) group of 24 frankfurters were individually placed in a plastic bag such that each frankfurter was completely immersed in the prepared acidic solution for 30 seconds. Following treatment each frankfurter was immediately removed, allowed to drip for five (5) seconds and then placed in a bag with two other treated frankfurters. The frankfurters were incubated at 4° C. Aerobic bacteria associated with each frank were evaluated at weekly intervals. Bacteria were enumerated by rinsing the C and T frankfurters with 50 ml of phosphate buffer, pH 7.0. An aliquot of the saline wash from each frankfurter was then serially diluted and a portion of each dilution was plated to determine the number of aerobic bacteria. Results are shown in the tables below. (“N.D.” means the bacterial CFU's were non-detectable).

TABLE 4
Results for Turkey Frankfurters

| Weeks Post- | | |
|---|---|---|
| Treatment | Control (Mean CFU/Frank) | Treated (Mean CFU/Frank) |
| 0 | 1 × 10⁴ | N.D. |
| 1 | 1.6 × 10⁴ | N.D. |
| 2 | — | N.D. |
| 3 | 3.5 × 10⁶ | 3.4 × 10³ |
| 4 | 2.5 × 10⁷ | 1.1 × 10² |
| 5 | 8.4 × 10⁷ | 7.1 × 10³ |
| 6 | 5.1 × 10⁹ | 1.5 × 10⁵ |
| 7 | — | 2.1 × 10³ |

TABLE 5
Results for Chicken Frankfurters

| Weeks Post- | | |
|---|---|---|
| Treatment | Control (Mean CFU/Frank) | Treated (Mean CFU/Frank) |
| 0 | 1.3 × 10⁴ | 5.6 × 10³ |
| 1 | 3.0 × 10⁴ | N.D. |
| 2 | 3.2 × 10⁹ | 5.0 × 10³ |
| 3 | 8.8 × 10¹⁰ | 7.0 × 10³ |
| 4 | 8.7 × 10⁹ | 2.7 × 10⁴ |
| 5 | 1.0 × 10¹⁰ | 3.4 × 10⁴ |
| 6 | 1.5 × 10⁹ | 1.1 × 10⁵ |
| 7 | 1.3 × 10⁹ | 1.6 × 10⁵ |

As shown above in Table 4, with respect to the turkey frankfurters, substantial differences in the number of associated aerobic bacteria were noted immediately after treatment. Even after seven weeks of incubation at 4-8° C., the number of bacteria associated with the treated frankfurters was little more than that associated with the control frankfurters at the start of the study. Also, the bacteria associated with the treated frankfurters did not show an increase at the seventh week after treatment. The acidic solution effectively stopped replication of aerobic bacteria for three weeks. Over the seven week incubation time it reduced bacterial replication relative to the control by about 5 logs.

As shown above in Table 5, with respect to the chicken frankfurters, there was more than a 6 log difference in the number of aerobic bacteria associated with treated chicken frankfurters as compared to the control group after two weeks of incubation. Over the seven weeks of incubation at 4° C., the number of bacteria associated with the treated chicken frankfurters increased only by about one log, whereas the number associated with the control frankfurters increased more than 5.5 logs after only four weeks of incubation.

The acidic solution appears to effectively eliminate and/or inhibit replication of aerobic bacteria associated with turkey and chicken frankfurters incubated at 4° C., thereby increasing the shelf life of frankfurter products. Because none of the treated group reached the level of bacteria associated with the end of shelf life, or 10⁶, it is estimated that the acidic solution can extend shelf life by several weeks.

1. A method for reducing pathogenic microorganisms in a food product comprising:
contacting the food product with an acidic composition, wherein the acidic composition comprises an organic acid in an amount ranging from about 40,000 ppm to about 300,000 ppm.

2. The method of claim 1, wherein the organic acid is selected from the group consisting of propionic acid, lactic acid, acetic acid, butyric acid, citric acid, glycolic acid, pyruvic acid, ascorbic acid, benzoic acid, sorbic acid, gluconic acid, and a mixture thereof.

3. The method of claim 1, wherein the amount of the organic acid ranges from about 45,000 ppm to about 250,000 ppm.

4. The method of claim 1, wherein the amount of the organic acid ranges from about 50,000 ppm to about 150,000 ppm.

5. The method of claim 1, wherein the acidic composition further comprises an acidulant, and wherein the acidulant is a strong inorganic acid or an acidic salt.

6. The method of claim 5 wherein the inorganic acid is sulfuric acid, phosphoric acid, hydrochloric acid, or a mixture thereof.

7. The method of claim 5 wherein, based on the total weight of the composition, the inorganic acid ranges from about 1% to about 85%.

8. The method of claim 5, wherein the pH of the acidic composition is from about 1.0 to about 5.0.

9. The method of claim 5, wherein the acidic salt is a mono-basic salt of phosphoric acid or a Group I bisulfate salt.

10. The method of claim 5, wherein the acidic salt is a Group I or II mono-basic salt of phosphoric acid.

11. The method of claim 1, wherein the acidic composition further comprises an additive.

12. The method of claim 11, wherein the additive comprises a metal salt, and wherein the metal salt is of an organic acid or an inorganic acid.

13. The method of claim 12, wherein the metal salt is a Group I or Group II metal salt of an organic acid or an inorganic acid.

14. The method of claim 12, wherein the metal salt is a metal salt of an organic acid, and wherein the amount of the metal salt ranges from about 5000 ppm to about 60,000 ppm.

15. The method of claim 14, wherein the amount of the metal salt ranges from about 10,000 ppm to about 55,000 ppm.

16. The method of claim 14, wherein the amount of the metal salt ranges from about 20,000 ppm to about 50,000 ppm.

17. The method of claim 12, wherein the metal salt is a metal salt of an inorganic acid, and wherein the amount of the metal salt ranges from about 5000 ppm to about 50,000 ppm.

18. The method of claim 17, wherein the amount of the metal salt ranges from about 10,000 ppm to about 40,000 ppm.

19. The method of claim 17, wherein the amount of the metal salt ranges from about 15,000 ppm to about 30,000 ppm.

20. The method of claim 12, wherein the metal salt is a Group I or II salt of sulfuric acid, phosphoric acid, or hydrochloric acid.

21. The method of claim 12, wherein the metal salt is a salt of propionic acid, lactic acid, acetic acid, butyric acid, citric acid, glycolic acid, pyruvic acid, ascorbic acid, benzoic acid, sorbic acid, or gluconic acid.

22. The method of claim 11, wherein the additive comprises a metal salt, and wherein the metal salt is created by adding base material to the acidic composition.

23. The method of claim 22, wherein the base material is a Group I or II hydroxide.

24. The method of claim 22, wherein the base material is a Group I or II carbonate.

25. The method of claim 22, wherein the amount of the base material ranges from about 5000 ppm to about 60,000 ppm.

26. The method of claim 22, wherein the amount of the base material ranges from about 10,000 ppm to about 40,000 ppm.

27. The method of claim 22, wherein the amount of the base material ranges from about 15,000 ppm to about 30,000 ppm.

28. The method of claim 11, wherein the additive comprises an alcohol.

29. The method of claim 28, wherein the alcohol is ethanol.

30. The method of claim 28, wherein, based on the final volume of the composition, the amount of the alcohol ranges from about 0.025% to about 5%.

31. The method of claim 28, wherein, based on the final volume of the composition, the amount of the alcohol ranges from about 0.05% to about 2%.

32. The method of claim 28, wherein, based on the final volume of the composition, the amount of the alcohol ranges from about 0.075% to about 1%.

33. The method of claim 11, wherein the additive comprises a surfactant.

34. The method of claim 33, wherein the surfactant is anionic, nonionic, amphoteric, or a mixture thereof.

35. The method of claim 33, wherein the surfactant is polypropyleneglycol, polysorbate, SDS, LAS, DBSA, or a mixture thereof.

36. The method of claim 33, wherein the amount of the surfactant ranges from about 100 ppm to about 20,000 ppm.

37. The method of claim 33, wherein the amount of the surfactant ranges from about 250 ppm to about 10,000 ppm.

38. The method of claim 33, wherein the amount of the surfactant ranges from about 500 ppm to about 5000 ppm.

39. The method of claim 33, wherein the acidic composition further comprises oleic acid.

40. The method of claim 11, wherein the additive comprises a peroxide.

41. The method of claim 40, wherein the peroxide is hydrogen peroxide, calcium peroxide, peracetic acid, or sodium peroxide.

42. The method of claim 40, wherein the amount of the peroxide ranges from about 25 ppm to about 150 ppm.

43. The method of claim 40, wherein the amount of the peroxide ranges from about 40 ppm to about 90 ppm.

44. The method of claim 40, wherein the amount of the peroxide ranges from about 50 ppm to about 80 ppm.

45. The food product prepared in accordance with the method of claim 11.

46. The method of claim 11, wherein the food product is a ready-to-eat food product or an animal carcass.

47. The ready-to-eat food product prepared in accordance with the method of claim 46.

48. The method of claim 1, wherein the food product is a ready-to-eat food product or an animal carcass.

49. The method of claim 45, wherein the ready-to-eat food product is a ready-to-eat meat product.

50. The method of claim 1, wherein the food product is a prepared dough.

51. The food product prepared in accordance with the method of claim 1.

52. The ready-to-eat food product prepared in accordance with the method of claim 45.

53. The animal carcass prepared in accordance with the method of claim 45.

54. The ready-to-eat meat product prepared in accordance with the method of claim 46.

55. The prepared dough prepared in accordance with the method of claim 47.

56. A method for reducing pathogenic microorganisms in a ready-to-eat food product comprising:
contacting the food product with an acidic composition, wherein the acidic composition comprises an acidulant, wherein the acidulant is a low pH solution of sparingly-soluble Group IIA-complexes (“AGIIS”), a highly acidic metalated organic acid (“HAMO”), or a highly acidic metalated mixture of inorganic acids (“HAMMIA”).

57. The method of claim 56, wherein the AGIIS is isolated from a mixture comprising a mineral acid and a Group IIA hydroxide, or a Group IIA salt of a dibasic acid, or a mixture of the two.

58. The method of claim 57, wherein the Group IIA hydroxide is calcium hydroxide, the mineral acid is sulfuric acid, and the Group IIA salt of a dibasic acid is calcium sulfate.

59. The method of claim 56, wherein, based on the total weight of the composition, the AGIIS ranges from about 1% to about 85%.

60. The method of claim 56, wherein the highly acidic metalated organic acid (“HAMO”) is prepared by mixing ingredients comprising:
at least one regenerating acid having a first number of equivalents;
at least one metal base having a second number of equivalents; and
at least one organic acid, and
wherein the first number of equivalents of the regenerating acid is greater than that of the second number of equivalents of the metal base.

61. The method of claim 60, wherein the regenerating acid comprises a strong oxyacid of sulfur, phosphorus, nitrogen, chromium, or iodine.

62. The method of claim 60, wherein the regenerating acid comprises a strong oxyacid of molybdenum, tungsten, or selenium.

63. The method of claim 60, wherein the regenerating acid comprises sulfuric acid, phosphoric acid, or an acidic solution of sparingly-soluble Group IIA complexes.

64. The method of claim 63, wherein the acidic solution of sparingly-soluble Group IIA complexes is prepared by mixing ingredients comprising a mineral acid and a Group IIA hydroxide, or a Group IIA salt of a dibasic acid, or a mixture thereof.

65. The method of claim 64, wherein the Group IIA hydroxide comprises calcium hydroxide, the mineral acid comprises sulfuric acid, and the Group IIA salt of the dibasic acid comprises calcium sulfate.

66. The method of claim 60, wherein the metal base comprises a hydroxide, a carbonate, a bicarbonate, or an oxide of a metal.

67. The method of claim 60, wherein the metal base comprises a base of a Group IA element.

68. The method of claim 60, wherein the metal base comprises a base of a Group IIA element, but not beryllium.

69. The method of claim 60, wherein the metal base comprises a base of a Group IIIA element, but not boron.

70. The method of claim 60, wherein the metal base comprises a base of a metal of the first transition series.

71. The method of claim 60, wherein the metal base comprises a base of magnesium, calcium, ferrous, copper, or zinc.

72. The method of claim 60, wherein the metal base comprises a base of lead, bismuth, or tin.

73. The method of claim 56, wherein the highly acidic metalated mixture of inorganic acids (“HAMMIA”) is prepared by mixing ingredients comprising:
a salt of phosphoric acid; and
a preformed, or in-situ generated, solution or suspension of an acidic sparingly-soluble Group IIA complex (“AGIIS”), wherein the solution or suspension of AGIIS is in an amount sufficient to render the acidic pH of the composition to be less than about 2.

74. The method of claim 73, wherein the solution or suspension of AGIIS is isolated from a mixture comprising a mineral acid and a Group IIA hydroxide, or a Group IIA salt of a dibasic acid, or a mixture of the two.

75. The method of claim 74, wherein the Group IIA hydroxide is calcium hydroxide, the mineral acid is sulfuric acid, and the Group IIA salt of a dibasic acid is calcium sulfate.

76. The method of claim 73, wherein the salt of phosphoric acid comprises a divalent metal salt of phosphoric acid.

77. The method of claim 76, wherein the divalent metal comprises an alkali earth metal or a metal of first transition series.

78. The method of claim 73, wherein the salt of phosphoric acid comprises a mono-valent metal salt of phosphoric acid.

79. The method of claim 78, wherein the mono-valent metal comprises an alkali metal.

80. The method of claim 56, wherein the acidic composition further comprises an organic acid in an amount ranging from about 40,000 ppm to about 300,000 ppm.

81. The method of claim 80, wherein the organic acid is selected from the group consisting of propionic acid, lactic acid, acetic acid, butyric acid, citric acid, glycolic acid, pyruvic acid, ascorbic acid, benzoic acid, sorbic acid, gluconic acid, and a mixture thereof.

82. The method of claim 80, wherein the amount of the organic acid ranges from about 45,000 ppm to about 250,000 ppm.

83. The method of claim 80, wherein the amount of the organic acid ranges from about 50,000 ppm to about 150,000 ppm.

84. The method of claim 80, wherein the pH of the acidic composition is from about 1.0 to about 5.0.

85. The method of claim 56, wherein the acidic composition further comprises an additive.

86. The method of claim 85, wherein the additive comprises a metal salt, and wherein the metal salt is of an organic acid or an inorganic acid.

87. The method of claim 86, wherein the metal salt is a Group I or Group II metal salt of an organic acid or an inorganic acid.

88. The method of claim 86, wherein the metal salt is a metal salt of an organic acid, and wherein the amount of the metal salt ranges from about 5000 ppm to about 60,000 ppm.

89. The method of claim 88, wherein the amount of the metal salt ranges from about 10,000 ppm to about 55,000 ppm.

90. The method of claim 88, wherein the amount of the metal salt ranges from about 20,000 ppm to about 50,000 ppm.

91. The method of claim 86, wherein the metal salt is a metal salt of an inorganic acid, and wherein the amount of the metal salt ranges from about 5000 ppm to about 50,000 ppm.

92. The method of claim 91, wherein the amount of the metal salt ranges from about 10,000 ppm to about 40,000 ppm.

93. The method of claim 91, wherein the amount of the metal salt ranges from about 15,000 ppm to about 30,000 ppm.

94. The method of claim 86, wherein the metal salt is a Group I or II salt of sulfuric acid, phosphoric acid, or hydrochloric acid.

95. The method of claim 86, wherein the metal salt is a salt of propionic acid, lactic acid, acetic acid, butyric acid, citric acid, glycolic acid, pyruvic acid, ascorbic acid, benzoic acid, sorbic acid, or gluconic acid.

96. The method of claim 85, wherein the additive comprises a metal salt, and wherein the metal salt is created by adding base material to the acidic composition.

97. The method of claim 96, wherein the base material is a Group I or II hydroxide.

98. The method of claim 96, wherein the base material is a Group I or II carbonate.

99. The method of claim 96, wherein the amount of the base material ranges from about 5000 ppm to about 60,000 ppm.

100. The method of claim 96, wherein the amount of the base material ranges from about 10,000 ppm to about 40,000 ppm.

101. The method of claim 96, wherein the amount of the base material ranges from about 15,000 ppm to about 30,000 ppm.

102. The method of claim 85, wherein the additive comprises an alcohol.

103. The method of claim 102, wherein the alcohol is ethanol.

104. The method of claim 102, wherein, based on the final volume of the composition, the amount of the alcohol ranges from about 0.025% to about 5%.

105. The method of claim 102, wherein, based on the final volume of the composition, the amount of the alcohol ranges from about 0.05% to about 2%.

106. The method of claim 102, wherein, based on the final volume of the composition, the amount of the alcohol ranges from about 0.075% to about 1%.

107. The method of claim 85, wherein the additive comprises a surfactant.

108. The method of claim 107, wherein the surfactant is anionic, nonionic, amphoteric, or a mixture thereof.

109. The method of claim 107, wherein the surfactant is polypropyleneglycol, polysorbate, SDS, LAS, DBSA, or a mixture thereof.

110. The method of claim 107, wherein the amount of the surfactant ranges from about 100 ppm to about 20,000 ppm.

111. The method of claim 107, wherein the amount of the surfactant ranges from about 250 ppm to about 10,000 ppm.

112. The method of claim 107, wherein the amount of the surfactant ranges from about 500 ppm to about 5000 ppm.

113. The method of claim 107, wherein the acidic composition further comprises oleic acid.

114. The method of claim 85, wherein the additive comprises a peroxide.

115. The method of claim 114, wherein the peroxide is hydrogen peroxide, calcium peroxide, peracetic acid, or sodium peroxide.

116. The method of claim 114, wherein the amount of the peroxide ranges from about 25 ppm to about 150 ppm.

117. The method of claim 114, wherein the amount of the peroxide ranges from about 40 ppm to about 90 ppm.

118. The method of claim 114, wherein the amount of the peroxide ranges from about 50 ppm to about 80 ppm.

119. The method of claim 85, wherein the ready-to-eat food product is a ready-to-eat meat product.

120. The ready-to-eat food product prepared in accordance with the method of claim 85.

121. The ready-to-eat meat product prepared in accordance with the method of claim 119.

122. The method of claim 56, wherein the ready-to-eat food product is a ready-to-eat meat product.

123. The ready-to-eat food product prepared in accordance with the method of claim 56.

124. The ready-to-eat meat product prepared in accordance with the method of claim 123.
